(19) United States
(12) Patent Application Publication
(10) Pub. No.: US 2025/0169499 A1
(43) Pub. Date: May 29, 2025

(54) IMAZAMOX AND GLYPHOSATE FOR CONTROLLING DIGITARIA INSULARIS

(71) Applicant: BASF AGROCHEMICAL PRODUCTS B.V., Arnhem (NL)

(72) Inventors: Ricardo Boccato Pires De Camargo, Campinas (BR); Breno Augusto Da Cunha, Sao Paolo (BR); Ana Paula Meirelles Menzani, Jaguariuna (BR)

(21) Appl. No.: 18/695,023

(22) PCT Filed: Sep. 27, 2022
(86) PCT No.: PCT/EP2022/076842

§ 371 Date: Mar. 25, 2024

(30) Foreign Application Priority Data
Sep. 28, 2021 (EP) 21199504.8

(51) Int. Cl. A01N 43/50; A01N 57/20; A01P 13/00

(52) U.S. Cl. CPC A01N 43/50; A01N 57/20; A01P 13/00

(57) ABSTRACT

The present invention relates to a method for controlling Digitaria insularis plants, which comprises applying a binary herbicide combination of i. a herbicide A selected from glyphosate and salts of glyphosate, and ii. a herbicide B selected from imazamox and salts of imazamox, to an area, where Digitaria insularis plants grow or may grow, wherein the weight ratio of the herbicide A to the herbicide B in the combination is in the range of 1:2 to 120:1. The present invention also relates to use of said binary herbicide combination of a herbicide A and a herbicide B for controlling Digitaria insularis plants, wherein the weight ratio of the herbicide A to the herbicide B in the combination is in the range of 1:2 to 120:1.

The present invention relates to a method for controlling Digitaria insularis plants, which comprises applying a binary herbicide combination of a herbicide A selected from glyphosate and salts of glyphosate, and a herbicide B selected from imazamox, salts of imazamox and esters of imazamox to an area where Digitaria insularis plants grow or may grow, as described herein.

The present invention also relates to the use of said binary herbicide combination of a herbicide A and a herbicide B for controlling Digitaria insularis plants, as described herein.

### BACKGROUND ON THE INVENTION

Digitaria insularis plants (D. insularis) are one of the main weeds in the soybean crop and particularly difficult to control. Due to their characteristic plant properties, such as tufted formation, rhizome structures and high seed production, they infest large agricultural areas, especially in off season, where no crop covers such areas. Moreover, when D. insularis plants develop and form their rhizomes, the control by herbicide becomes much more ineffective compared to their earlier growth stage. As D. insularis plants grow much quicker than crop plants, they compete very early in the growing season, thereby damaging the crop plants and reducing crop yield. Thus, it is desirable to develop methods which effectively control D. insularis in broad spectrum of their plant growth stages.

Glyphosate and its salts are non-selective systemic herbicides having a good post-emergence activity against numerous grass weeds. So far, glyphosate is one of the most commonly used herbicides and has been frequently applied to control D. insularis plants. However, solo application of glyphosate often yields unsatisfactory weed control and usually requires high application dosage rates. This can lead to undesirable increased selection pressure and herbicide resistance of weeds, especially D. insularis plants. Moreover, the effectiveness of glyphosate against D. insularis plants, especially to D. insularis resistant to glyphosate, is particularly poor. Therefore, it is frequently recommended to apply glyphosate in combination with at least one second herbicide, e.g. acetyl-CoA carboxylase (ACCase) inhibitors herbicides, such as clethodim, haloxyfop and quizalofop.

Correia et al. Planta Daninha, 33 (1): 93 (2015) carried out experiments to control different populations of D. insularis by glyphosate. Glyphosate was used either alone (1.44 and 2.16 kg/ha) or mixed with quizalofop (0.12 kg/ha) to manage resistant adult plants. The treatment of glyphosate plus quizalofop was sufficient for adequate control (>95%) of all populations. However, some populations were tolerant or showed only moderate sensitivity to the herbicide.

Bauer et al. Rev. Fac. Nac. Agron. Medellín 74(1): 9403 (2021) carried out a study aimed to evaluate the D. insularis control by glyphosate in association with ACCase inhibitors, such as clethodim and haloxyfop, and latifolicides, such as 2,4-D, triclopyr, dicamba, carfentrazone, saflufenacil and chlorimuron in two different locations. An antagonism for all synthetic auxins was observed with glyphosate with clethodim or haloxyfop mixtures, in both locations. In one location, the herbicide associations were not effective, even with the post-emergence application in soybean of glyphosate with clethodim.

As shown, the effectiveness of such combinations is often not satisfactory, and high application rates are still required to achieve an acceptable control of D. insularis. Therefore, it is still required to find better combinations of glyphosate and at least one second herbicide.

Imazamox is a selective broad-spectrum herbicide with contact and residual activities, used post-emergence for the control of broadleaf and grass weeds in soybeans and other vegetables grown in rotation with sugar beet and other crops. It belongs to the chemical group of imidazolinones, which is one of the most important ALS inhibitor herbicides along with the large group of sulfonylureas. There are several attempts to combine glyphosate with imazamox to obtain enhanced herbicidal effects.

Fernández-Escalada et al. Sci Rep 9: 18225 (2019) carried out a study to evaluate the physiological effects in the mixture of glyphosate and imazamox in glyphosate-sensitive and-resistant populations of the troublesome weed Amaranthus palmeri. They found out that in the population of A. palmeri, glyphosate and imazamox applied together are physiologically antagonistic.

U.S. Pat. No. 6,214,768 describes methods for the synergistic control of undesirable plants such as Ipomoea, Cyperus, Sida or Euphorbia with a combination of glyphosate and at least one imidazolinone compound selected from the group consisting of imazethapyr, imazaquin, imazapic, imazamox, imazapyr, R isomers thereof or salts thereof, and mixtures thereof. U.S. Pat. No. 6,214,768 does not suggest whether the combinations are suitable for the control of D. insularis plants.

U.S. Pat. No. 6,277,787 describes mixtures of a glyphosate herbicide and an imidazolinone herbicide for control of weeds of the group of Ipomoea, Cyperus, Sida and Euphorbia in a field of a glyphosate-tolerant crops such as soybean, canola, sugarbeet, or cotton. U.S. Pat. No. 6,277,787 does not suggest whether the combinations are suitable for the control of D. insularis plants.

BR 102015029158 describes ternary herbicidal mixtures of a glyphosate herbicide and at least two non-glyphosate herbicides for control of inter alia D. insularis, wherein at least one non-glyphosate herbicide is a cyclohexeneoxime, such as clethodim, and at least one further non-glyphosate herbicide is selected from imidazolinones, such as imazapic and imazapyr.

### SUMMARY OF THE INVENTION

It is an object of the present invention to provide a method for controlling D. insularis plants using a herbicidal composition or combination which allows efficient and reliable control of D. insularis. Moreover, the persistence of the herbicidal activity of the composition or combination should be sufficiently long in order to achieve control of D. insularis over a sufficiently long time period, thus allowing a more flexible application. The composition or combination should also have a low toxicity to crop species to be protected from the D. insularis and humans or other mammals. The composition or combination should also show an accelerated action on harmful plants, i.e. they should effect damaging of the harmful plants more quickly in comparison with application of the individual herbicides.

Surprisingly, it has now been found that the binary herbicide combination of glyphosate and/or its salts with imazamox and/or its salts and/or its esters provides synergistic control of D. insularis if the weight ratio of glyphosate to imazamox is in the range of 1:2 to 120:1, in particular in the range of 1:1 to 50:1, particularly in the range of 2:1 to 25:1, more particularly in the range of 5:1 to 22:1, even more particularly in the range of 8:1 to 22:1, especially in the range of 8:1 to 19.5:1, more specifically in the range of 9:1 to 19.5:1, preferably in the range of 10:1 to 19:1, or in the range of 10:1 to 18:1, wherein the weight ratio of glyphosate to imazamox refers to the weight of the acid form of glyphosate and imazamox, respectively. Advantageously, the use of the synergistic binary herbicide combination of the invention allows for lower application rates of glyphosate and/or its salts and imazamox and/or its salts compared to the solo application of either glyphosate and/or its salts or imazamox and/or its salts against D. insularis. Moreover, the synergistic herbicidal methods and compositions of the invention allow for effective glyphosate-resistance management and provide improved control of D. insularis plants, especially in glyphosate-tolerant crop production such as glyphosate-tolerant soybean.

Therefore, the present invention relates to a method for controlling D. insularis plants, which comprises applying a binary herbicide combination of
i. a herbicide A selected from glyphosate and salts of glyphosate, and
ii. a herbicide B selected from imazamox, salts of imazamox and esters of imazamox,
   to an area where D. insularis plants grow or may grow,
   wherein the weight ratio of the herbicide A to the herbicide B in the combination is in the range of 1:2 to 120:1, in particular in the range of 1:1 to 50:1, particularly in the range of 2:1 to 25:1, more particularly in the range of 5:1 to 22:1, even more particularly in the range of 8:1 to 22:1, especially in the range of 8:1 to 19.5:1, more specifically in the range of 9:1 to 19.5:1, preferably in the range of 10:1 to 19:1, more preferably in the range of 10:1 to 18:1, wherein the weight ratio of glyphosate to imazamox refers to the weight of the acid form of glyphosate and imazamox, respectively.

A further aspect of the present invention is the use of the said binary herbicide combination of the herbicide A and B, as described herein, for controlling D. insularis plants,

wherein the weight ratio of the herbicide A to the herbicide B in the combination is in the range of 1:2 to 120:1, in particular in the range of 1:1 to 50:1, particularly in the range of 2:1 to 25:1, more particularly in the range of 5:1 to 22:1, even more particularly in the range of 8:1 to 22:1, especially in the range of 8:1 to 19.5:1, more specifically in the range of 9:1 to 19.5:1, preferably in the range of 10:1 to 19:1, more preferably in the range of 10:1 to 18:1, wherein the weight ratio of glyphosate to imazamox refers to the weight of the acid form of glyphosate and imazamox, respectively.

The binary herbicide combination of the present invention has several advantages over solo application of either glyphosate and/or its salts or imazamox and/or its salts and/or its esters against D. insularis.
The binary herbicide combination of the present invention shows enhanced herbicide action in comparison with the herbicide action of solo action of either glyphosate or imazamox against D. insularis.
The binary herbicide combination of the invention shows a persistent herbicidal activity, even under difficult weathering conditions, which allows a more flexible application and minimizes the risk of weeds escaping.
The binary herbicide combination of the present invention is generally non-toxic or of low toxicity against mammals.
The binary herbicide combination of the present invention shows superior crop compatibility with certain conventional crop plants and with herbicide tolerant crop plants, i.e. their use in these crops leads to a reduced damage of the crop plants and/or does not result in increased damage of the crop plants in burndown pre-planting, without any interval restrictions Thus, the binary herbicide combination of the invention can also be applied after the emergence of the crop plants tolerant to glyphosate.
The binary herbicide combination of the present invention may also show an accelerated action on D. insularis plants, i.e. they may affect damage of the harmful plants more quickly in comparison with solo application of the individual herbicides.
The binary herbicide combination of the invention is suitable for controlling D. insularis plants that are glyphosate-tolerant.

### DETAILED DESCRIPTION OF THE INVENTION

As used herein, the terms “controlling” and “combating” are synonyms, referring to inhibition of growth, control of growth, reduction of growth or complete destruction of D. insularis plants.

As used herein, binary herbicide composition refers to compositions of two different herbicide compounds which do not comprise a further herbicide compound. Different salts of the same herbicide compound are considered as the same herbicide compound. Thus, the present invention relates to herbicide compositions comprising the herbicide A and the herbicide B as sole herbicide components of the composition.

As used herein “herbicide” refers to one or more agents, compounds and/or compositions having herbistatic and/or herbicidal activity.

As used herein, the terms “undesirable vegetation”, “undesirable species”, “undesirable plants”, “harmful plants”, “undesirable weeds”, “volunteer plants” or “harmful weeds” are used synonymously and mean D. insularis plants.

As used herein, “post emergence” refers to an herbicide treatment that is applied to an area after the weeds have germinated and emerged from the ground or growing medium.

As used herein, “burndown” refers to when an herbicide is used to reduce weed presence at the time of treatment. Burndown is often used in minimum or no-till fields because the weeds cannot be managed by tilling the soil. The burndown application may be used post-harvest and/or prior to crop emergence. Burndown is especially useful against weeds that emerge between growing seasons.

As used herein, the terms “synergistic effect” and “synergism” are used synonymously and mean that the application of the combination of herbicidal components demonstrates a greater herbicidal effect than expected from the effect of the application of the individual herbicidal components when applied singly.

Synergism can be determined by the Colby method (Colby, S. R., Weeds, 1967(15), p. 20-22), i.e. the expected (or predicted) response of the combination is calculated by taking the product of the observed response for each individual component of the combination when applied alone divided by 100 and subtracting this value from the sum of the observed response for each component when applied alone. Synergism of the combination is then determined by comparing the observed response of the combination to the expected (or predicted) response as calculated from the observed responses of each individual component alone. If the observed response of the combination is significantly greater than the expected (or predicted) response as determined by Fisher's protected Least Significant Difference (LSD) test using significance level 0.05, than the combination is said to be synergistic.

The foregoing is illustrated mathematically as follows:

$$( X + Y ) - \frac{X Y}{100} = Expected response ( Exp . )$$

$$and$$

$$Synergism = ( Obs . - Exp . ) > LSD ,$$

wherein a combination is composed of components X and Y, and Obs. designates the observed response of this combination. The synergistic effect may also be given as the ratio of the observed response and the expected response in percent, i.e.

$$synergistic effect [ \% ] = Obs . / Exp . \times 100$$

Glyphosate [common name of N-(phosphonomethyl)glycine] is a well-known non-selective systemic herbicide, which has been described e.g. in U.S. Pat. No. 3,799,758 and U.S. Pat. No. 4,4505,531. Glyphosate is commercially available e.g. from Monsanto under the tradenames Roundup™ and Touchdown™. Glyphosate is also available and marketed in the form of its agriculturally acceptable salts, such as glyphosate-diammonium [69254-40-6], glyphosate-isopropylammonium [38641-94-0], glyphosate-monoammonium [40465-66-5], glyphosate-potassium [70901-20-1], glyphosate-sesquisodium [70393-85-0], or glyphosate-trimesium [81591-81-3]. Preferably, glyphosate is present in the composition in the form of its potassium, monoammonium, diammonium, isopropylammonium or trimesium salt.

Imazamox [common name of 2-(4-isopropyl-4-methyl-5-oxo-2-imidazolin-2-yl)-5-(methoxymethy l)nicotinic acid] is a well-known selective broad-spectrum herbicide, which has been described e.g. in U.S. Pat. Nos. 6,214,768, 6,127,317 and 6,277,787. Imazamox and the R isomer thereof or the agriculturally acceptable salts thereof are commercially available, e.g. from BASF SE under the tradename Clearfield-Vantiga.

Imazamox is one of the imidazolinone herbicides that belong to ALS inhibitors and are known e.g. from Shaner, D. L. O'Conner, S. L The Imidazolinone Herbicides, CRC Press Inc., Boca Raton, Florida 1991 and also from The Compendium of Pesticide Common Names http://www.alanwood.net/pesticides/.

The terms “glyphosate” and “imazamox” relate to the acid form of these compounds, unless it is clear from the context that these terms are used as pars pro toto terms and stand also for the salt or ester form thereof.

Glyphosate and imazamox can be present in their acid form and in the form of their agriculturally acceptable salts. In general, the salts of those cations are suitable whose cations have no adverse effect on the action of the active compounds (“agriculturally acceptable”).

Preferred cations are, for example, but not limited to the ions of the alkali metals, preferably of lithium, sodium and potassium, of the alkaline earth metals, preferably of calcium and magnesium, and of the transition metals, preferably of manganese, copper, zinc and iron, furthermore ammonium and substituted ammonium (hereinafter also termed as organoammonium) in which one to four hydrogen atoms are replaced by C₁-C₄-alkyl, hydroxy-C₁-C₄-alkyl, C₁-C₄-alkoxy-C₁-C₄-alkyl, hydroxy-C₁-C₄-alkoxy-C₁-C₄-alkyl, phenyl or benzyl, preferably ammonium, methylammonium, isopropylammonium, dimethylammonium, diisopropylammonium, trimethylammonium, tetramethylammonium, tetraethylammonium, tetrabutylammonium, pentylammonium, hexylammonium, heptylammonium, 2-hydroxyethylammonium, 2-(2-hydroxyethoxy)eth-1-ylammonium, (diglycolamine salts), di(2-hydroxyeth-1-yl)ammonium (diolamine salts), tris((2-hydroxyeth-1-yl)ammonium (trolamine salts), tris(3-propanol)amonium, benzyltrimethylammonium, benzyltriethylammonium, furthermore phosphonium ions, sulfonium ions, preferably tri(C₁-C₄-alkyl)sulfonium such as trimethylsulfonium, and sulfoxonium ions, preferably tri(C₁-C₄-alkyl)sulfoxonium.

Here and throughout the specification, the prefixes “Cₙ-Cₘ” used in connection with compounds or molecular moieties each indicate a range for the number of possible carbon atoms that a molecular moiety or a compound can have. The term “C₁-Cₙ-alkyl” denominates a group of linear or branched saturated hydrocarbon radicals having from 1 to n carbon atoms.

For example, the term “C₁-C₄-alkyl” denominates a group of linear or branched saturated hydrocarbon radicals having from 1 to 4 carbon atoms. C₁-C₄-Alkyl is methyl, ethyl, n-propyl, isopropyl, n-butyl, sec-butyl, isobutyl, or tert-butyl.

The term “hydroxyalkyl” as used herein refers to a saturated, straight-chain or singly, doubly, or triply branched hydrocarbon chain replaced by a hydroxyl group (—OH). The term “hydroxy-C₁-C₄-alkyl” denominates a C₁-C₄-alkyl group, as defined above, in which a hydrogen atom is replaced by a hydroxyl group. Examples thereof include, but are not limited to hydroxymethyl, 1-hydroxyethyl, 2-hydroxyethyl, 1-hydroxy-n-propyl, 2-hydroxy-n-propyl, 3-hydroxy-n-propyl, 1-hydroxy-2-propyl, 1-hydroxy-n-butyl, 2-hydroxy-n-butyl, 3-hydroxy-n-butyl, 4-hydroxy-n-butyl, and the like.

The term “C₁-C₄-alkoxy” relates to a C₁-C₄-alkyl group, as defined above, which is bound to the remainder of the molecule via an oxygen atom. Examples are methoxy, ethoxy, n-propoxy, 1-methylethoxy (isopropoxy), butoxy, 1-methylpropoxy (sec-butoxy), 2-methylpropoxy (isobutoxy) or 1,1-dimethylethoxy (tert-butoxy).

The term “alkoxyalkyl” as used herein refers to a saturated, straight-chain or singly, doubly, or triply branched hydrocarbon chain interrupted by an oxygen atom. Alternatively expressed, alkoxyalkyl is an alkyl group in which a hydrogen atom is replaced by an alkoxy group. The term “C₁-C₄-alkoxy-C₁-C₄-alkyl” refers to a C₁-C₄-alkyl group, as defined above, in which a hydrogen atom is replaced by C₁-C₄-alkoxy group, as defined above. Examples thereof include, but are not limited to methoxymethyl, ethoxymethyl, n-propoxymethyl, isopropoxymethyl, n-butoxymethyl, sec-butoxymethyl, isobutoxymethyl, tert-butoxymethyl, 1-methoxyethyl, 2-methoxyethyl, 1-ethoxyethyl, 2-ethoxyethyl, 1-(n-propoxy)-ethyl, 2-(n-propoxy)-ethyl, 1-isopropoxyethyl, 2-isopropoxyethyl, 1-(n-butoxy)-ethyl, 2-(n-butoxy)-ethyl, 1-methoxy-n-propyl, 2-methoxy-n-propyl, 3-methoxy-n-propyl, 1-ethoxy-n-propyl, 2-ethoxy-n-propyl, 3-ethoxy-n-propyl, 1-(n-propoxy)-n-propyl, 2-(n-propoxy)-n-propyl, 3-(n-propoxy)-n-propyl, 1-(isopropoxy)-n-propyl, 2-(isopropoxy)-n-propyl, 3-(isopropoxy)-n-propyl, 1-(n-butoxy)-n-propyl, 2-(n-butoxy)-n-propyl, 3-(n-butoxy)-n-propyl, 1-methoxy-prop-2-yl, 2-methoxy-prop-2-yl, 1-ethoxy-prop-2-yl, 2-ethoxy-prop-2-yl, 1-(n-propoxy)-prop-2-yl, 2-(n-propoxy)-prop-2-yl, 1-isopropoxy-prop-2-yl, 2-isopropoxy-prop-2-yl, 1-methoxy-n-butyl, 2-methoxy-n-butyl, 3-methoxy-n-butyl, 4-methoxy-n-butyl, 1-ethoxy-n-butyl, 2-ethoxy-n-butyl, 3-ethoxy-n-butyl, 4-ethoxy-n-butyl, 1-(n-propoxy)-n-butyl, 2-(n-propoxy)-n-butyl, 3-(n-propoxy)-n-butyl, 4-(n-propoxy)-n-butyl, 1-isopropoxy-n-butyl, 2-isopropoxy-n-butyl, 3-isopropoxy-n-butyl, 4-isopropoxy-n-butyl, 1-(n-butoxy)-n-butyl, 2-(n-butoxy)-n-butyl, 3-(n-butoxy)-n-butyl, 4-(n-butoxy)-n-butyl, and the like.

The term “hydroxyalkoxyalkyl” as used herein refers to an alkoxyalkyl group, as defined above, in which a hydrogen atom in the alkoxy moiety is replaced by a hydroxyl group. The term “hydroxy-C₁-C₄-alkoxy-C₁-C₄-alkyl” denominates a C₁-C₄-alkoxy-C₁-C₄-alkyl group, as defined above, wherein a hydrogen atom of the C₁-C₄-alkoxy group is replaced by a hydroxyl group. The hydroxyl group is preferably not on the same carbon atom bound to the oxygen atom via which the alkoxy group is attached to the alkyl group. Examples thereof include, but are not limited to (2-hydroxyethoxy)-methyl, (2-hydroxy-n-propoxy)-methyl, (3-hydroxy-n-propoxy)-methyl, (1-hydroxyprop-2-oxy)-methyl, 1-(2-hydroxyethoxy)-ethyl, 2-(2-hydroxyethoxy)-ethyl, 1-(2-hydroxy-n-propoxy)-ethyl, 1-(3-hydroxy-n-propoxy)-ethyl, 2-(2-hydroxy-n-propoxy)-ethyl, 2-(3-hydroxy-n-propoxy)-ethyl, 1-(1-hydroxyprop-2-oxy)-ethyl, 2-(1-hydroxyprop-2-oxy)-ethyl, 1-(2-hydroxy-n-butoxy)-ethyl, 1-(3-hydroxy-n-butoxy)-ethyl, 1-(4-hydroxy-n-butoxy)-ethyl, 2-(2-hydroxy-n-butoxy)-ethyl, 2-(3-hydroxy-n-butoxy)-ethyl, 2-(4-hydroxy-n-butoxy)-ethyl, 1-(2-hydroxyethoxy)-n-propyl, 2-(2-hydroxyethoxy)-n-propyl, 3-(2-hydroxyethoxy)-n-propyl, 1-(2-hydroxypropoxy)-n-propyl, 1-(3-hydroxypropoxy)-n-propyl, 2-(2-hydroxypropoxy)-n-propyl, 2-(3-hydroxypropoxy)-n-propyl, 3-(2-hydroxypropoxy)-n-propyl, 3-(3-hydroxypropoxy)-n-propyl, 1-(1-hydroxyprop-2-oxy)-n-propyl, 2-(1-hydroxyprop-2-oxy)-n-propyl, 3-(1-hydroxyprop-2-oxy)-n-propyl, 1-(2-hydroxy-n-butoxy)-n-propyl, 1-(3-hydroxy-n-butoxy)-n-propyl, 1-(4-hydroxy-n-butoxy)-n-propyl, 2-(2-hydroxy-n-butoxy)-n-propyl, 2-(3-hydroxy-n-butoxy)-n-propyl, 2-(4-hydroxy-n-butoxy)-n-propyl, 3-(2-hydroxy-n-butoxy)-n-propyl, 3-(3-hydroxy-n-butoxy)-n-propyl, 3-(4-hydroxy-n-butoxy)-n-propyl, 1-(2-hydroxyethoxy)-n-butyl, 2-(2-hydroxyethoxy)-n-butyl, 3-(2-hydroxyethoxy)-n-butyl, 4-(2-hydroxyethoxy)-n-butyl, 1-(2-hydroxy-n-propoxy)-n-butyl, 1-(3-hydroxy-n-propoxy)-n-butyl, 2-(2-hydroxy-n-propoxy)-n-butyl, 2-(3-hydroxy-n-propoxy)-n-butyl, 3-(2-hydroxy-n-propoxy)-n-butyl, 3-(3-hydroxy-n-propoxy)-n-butyl, 4-(2-hydroxy-n-propoxy)-n-butyl, 4-(3-hydroxy-n-propoxy)-n-butyl, 1-(1-hydroxyprop-2-oxy)-n-butyl, 2-(1-hydroxyprop-2-oxy)-n-butyl, 3-(1-hydroxyprop-2-oxy)-n-butyl, 4-(1-hydroxyprop-2-oxy)-n-butyl, 1-(2-hydroxy-n-butoxy)-n-butyl, 1-(3-hydroxy-n-butoxy)-n-butyl, 1-(4-hydroxy-n-butoxy)-n-butyl, 2-(2-hydroxy-n-butoxy)-n-butyl, 2-(3-hydroxy-n-butoxy)-n-butyl, 2-(4-hydroxy-n-butoxy)-n-butyl, 3-(2-hydroxy-n-butoxy)-n-butyl, 3-(3-hydroxy-n-butoxy)-n-butyl, 3-(4-hydroxy-n-butoxy)-n-butyl, 4-(2-hydroxy-n-butoxy)-n-butyl, 4-(3-hydroxy-n-butoxy)-n-butyl, 4-(4-hydroxy-n-butoxy)-n-butyl, and the like.

In a preferred embodiment of the invention, the glyphosate salt is selected from the group consisting of glyphosate-monoammonium, glyphosate-diammonium, glyphosate-isopropylammonium, glyphosate-potassium, glyphosate-sesquisodium and glyphosate-trimesium. In a specific embodiment, herbicide A is used in form of glyphosate-potassium (i.e. the potassium salt of glyphosate).

Suitable salts of imazamox are for example, but not limited to sodium salts, potassium salts, ammonium salts or substituted ammonium salts as defined above, examples for the latter being in particular mono-, di- and tri-C₁-C₈-alkylammonium salts such as the isopropylammonium salt. Suitable examples of such salts include imazamox-ammonium, imazamox-isopropylammonium and imazamox-sodium.

Examples of C₁-C₈-alkyl include, but are not limited to methyl, ethyl, n-propyl, isopropyl, n-butyl, sec-butyl, isobutyl, tert-butyl, pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, heptyl, octyl, 2-ethylhexyl and other positional isomers thereof.

Suitable esters of imazamox are for example, but not limited to its C₁-C₈-alkyl esters, such as the methyl ester, the ethyl ester, the isopropyl ester. Suitable examples of such esters include imazamox-methyl, imazamox-ethyl and imazamox-isopropyl.

In a preferred embodiment, the herbicide B is selected from the group consisting of salts and esters of imazamox, as well as mixtures thereof.

In another preferred embodiment, the herbicide B is selected from the group consisting of imazamox (i.e. in its acid form) and salts of imazamox.

In a further preferred embodiment of the invention, the herbicide B is an imazamox salt selected from the group consisting of imazamox-monoammonium, imazamox C₁-C₄-alkylammonium salts, such as imazamox-isopropylammonium, imazamox di-(C₁-C₄-alkyl)-ammonium salts, imazamox-potassium and imazamox-tri-(C₁-C₄-alkyl)sulfonium.

In a particularly preferred embodiment of the invention, the imazamox salt is selected from the group consisting of imazamox-monoammonium, and imazamox-isopropylammonium.

Imazamox may be present in the form of its racemate or in the form of the pure R- or S-enantiomer (including salts as defined above). Very suitable is the R-isomer, i.e. R-imazamox. The R-enantiomer is known e.g. from U.S. Pat. No. 5,973,154 B (American Cyanamid Company) and U.S. Pat. No. 6,339,158 B1 (American Cyanamid Company).

In a particularly preferred embodiment of the invention, the herbicide B is a R-enantiomer of imazamox.

Imazamox in its racemic acid form is however also very useful as herbicide B. Thus, in an alternatively preferred embodiment, herbicide B is used as imazamox in its racemic acid form.

In an embodiment of the method or the use of the invention, the weight ratio of the herbicide A to the herbicide B in the combination is in the range of 1:2 to 120:1, in particular in the range of 1:1 to 50:1, particularly in the range of 2:1 to 25:1, more particularly in the range of 5:1 to 22:1, even more particularly in the range of 8:1 to 22:1, especially in the range of 8:1 to 19.5:1, more specifically in the range of 9:1 to 19.5:1, preferably in the range of 10:1 to 19:1, or in the range of 10:1 to 18:1, wherein the weight ratio of glyphosate to imazamox refers to the weight of the acid form of glyphosate and imazamox, respectively.

Preferably, the method or the use of the invention comprises:
i. applying the herbicide A to an area, where D. insularis plants grow or may grow; and
ii. applying the herbicide B to said area,
   wherein the applying steps i) and ii) are performed either successively or simultaneously (jointly or separately), such that both the herbicide A and the herbicide B are present on said area in the weight ratio of A to B in the range of 1:2 to 120:1, in particular in the range of 1:1 to 50:1, particularly in the range of 2:1 to 25:1, more particularly in the range of 5:1 to 22:1, even more particularly in the range of 8:1 to 22:1, especially in the range of 8:1 to 19.5:1, more specifically in the range of 9:1 to 19.5:1, preferably in the range of 10:1 to 19:1, more preferably in the range of 10:1 to 18:1, wherein the weight ratio of glyphosate to imazamox refers to the weight of the acid form of glyphosate and imazamox, respectively.

In the case of successive application, the time interval between the treatments must be such that the desired effect can take place. The time interval may be from a few seconds up to several days, e.g. from a few seconds up to 24 h.

More preferably, the method or the use of the invention further comprises preparing a mixture of the herbicide A and the herbicide B prior to application.

The herbicide A is applied with an appropriate application rate. Suitable application rates of the herbicide A are in range from 0.24 to 2.4 kg/ha, in particular 0.72 to 1.92 kg/ha, especially 0.96 to 1.44 kg/ha, calculated as glyphosate in its acid form.

Likewise, the herbicide B is also applied with an appropriate application rate. Preferably, the herbicide B is applied with an application rate in range from 0.02 to 0.56 kg/ha, in particular 0.042 to 0.084 kg/ha, especially 0.049 to 0.105 kg/ha, calculated as imazamox in its acid form.

In a preferred group of embodiments, the herbicide A and the herbicide B are tank-mixed.

Though not necessary, it is possible to formulate the herbicides A and B in a single formulation. Usually the herbicides A and B are combined as a tank-mix prior to application. It is however also possible to provide a formulation of the herbicide B and to combine this formulation with a formulation of the herbicide A to obtain a co-formulation.

The binary herbicide combination of the herbicide A and B can be applied in conventional manner by using techniques a skilled person is familiar with. Suitable techniques include spraying, atomizing, dusting, spreading or watering. The type of application depends on the intended purpose in a well-known manner; in any case, it should ensure the finest possible distribution of the active ingredients.

The binary herbicide combination is applied to an area mainly by spraying, in particular foliar spraying of an aqueous dilution of the active ingredients of the composition. Application can be carried out by customary spraying techniques using, for example, water as carrier and spray liquor rates of from about 10 to 2000 l/ha or 50 to 1000 l/ha, for example from 100 to 500 l/ha. Application of the herbicidal compositions by the low-volume and the ultra-low-volume method is possible, as is their application in the form of microgranules.

If the active ingredients are less well tolerated by certain crop plants, application techniques may be used in which the herbicidal compositions are sprayed, with the aid of the spray apparatus, in such a way that they come into as little contact, if any, as possible with the leaves of the sensitive crop plants while reaching the leaves of undesirable plants which grow underneath, or the bare soil (post-directed, lay-by).

The binary herbicide combination can be applied pre-or post-emergence, i.e. before, during and/or after emergence of D. insularis plants.

The binary herbicide combination can be applied in a burndown program or in crops, in particular in crops which are glyphosate tolerant or resistant and/or which are tolerant or resistant against ALS inhibitors, such as imidazolinone herbicides.

When the binary herbicide combination is used in burndown programs, it can be applied prior to seeding (planting) or after seeding (or planting) of the crop plants but before the emergence of the crop plants. The combination is preferably applied prior to seeding of the crop plants. For burndown, the combination will generally be applied a date up to 9 months, frequently up to 6 months, preferably up to 4 months prior to planting the crop. The burndown application can be done at a date up to 1 day prior to emergence of the crop plant and is preferably done at a date prior to seeding/planting of the crop plant, preferably at a date of at least one day, preferably at least 2 days and in particular at least one 4 days prior to planting or from 6 months to 1 day prior emergence, in particular from 4 months to 2 days prior emergence and more preferably from 4 months to 4 days prior emergence. It is, of course, possible to repeat the burndown application once or more, e.g. once, twice, three times, four times or five times within that time frame.

In the burndown treatment, the at least one herbicide A and the herbicide B are applied to the field of the crop plants prior to the emergence of the crop plants, in particular prior to seeding within the above time frame.

It is a particular benefit of the binary herbicide combination that it has a very good post-emergence herbicide activity, i.e. it shows a good herbicidal activity against emerged undesirable plants. Thus, in a preferred embodiment of the invention, the combination is applied post-emergence, i.e. during and/or after, the emergence of the D. insularis plants. It is particularly advantageous to apply the combination post emergent when the D. insularis plants start with leaf development up to flowering, especially with at least above-ground basal branches, preferably with flowering stage, even in a perennial plant. The combination is particularly useful for controlling D. insularis plants which have already developed to a state which is difficult to control with conventional burndown compositions, i.e. when the individual weed is taller than 10 cm (4 inches) or even taller than 50 cm (20 inches) and/or for heavy weed populations.

Therefore, in a preferred embodiment of the method or the use of the present invention, the combination is applied to growing D. insularis plants, especially to the D. insularis plants that form at least above-ground basal branches, preferably to the D. insularis plants in a flowering stage in annual or perennial plants.

In the case of a post-emergence treatment of the plants, the binary herbicide combination is preferably applied by foliar application.

Application may be effected, for example, by usual spraying techniques with water as the carrier, using amounts of spray mixture of usually from 10 to 2000 l/ha, in particular 50 to 1000 l/ha.

The required application rate of the composition of the pure active compounds, i.e. of herbicides A and B depends on the density of D. insularis plants, on the development stage of the plants, on the climatic conditions of the location where the composition is used and on the application method. In general, the application rate of the composition, i.e. total amount of herbicides A and B, is from 55 to 6000 g/ha, preferably from 100 to 5000 g/ha, more preferably from 200 to 4000 g/ha, and even more preferably from 300 to 3000 g/ha of active ingredient (a.i.).

The rate of application of herbicide A is usually from 0.24 to 2.4 kg/ha, in particular 0.72 to 1.92 kg/ha, especially 0.96 to 1.44 kg/ha, calculated as glyphosate in its acid form.

The rate of application of herbicide B is usually from 0.02 to 0.56 kg/ha, in particular 0.042 to 0.084 kg/ha, especially 0.049 to 0.105 kg/ha, calculated as imazamox in its acid form.

The use of the binary herbicide combination of the invention achieves control of D. insularis plants, even if the D. insularis plants have acquired tolerance to glyphosate. Therefore, a particular embodiment of the invention relates to the method or use of the invention, where the herbicide combination as described herein is applied to D. insularis plants which are glyphosate-tolerant.

The method or the use of the present invention is particularly suitable for controlling D. insularis plants, wherein said binary herbicide combination of the herbicide A and B is applied to a culture of soybean, where the D. insularis plants grow or may grow.

In a preferred embodiment of the method or the use of the present invention, said combination is applied to an area, where it is intended to plant soybean.

The method or use of the present invention is suitable for burndown of D. insularis plants in fields of the following crops:
Grain crops, including e.g.
   cereals (small grain crops) such as wheat (Triticum aestivum) and wheat-like crops such as durum (T. durum), einkorn (T. monococcum), emmer (T. dicoccon) and spelt (T. spelta), rye (Secale cereale), triticale (Tritiosecale), barley (Hordeum vulgare);
   maize (corn; Zea mays);
   sorghum (e.g. Sorghum bicolour);
   rice (Oryza spp. such as Oryza sativa and Oryza glaberrima); and
   sugar cane;
Legumes (Fabaceae), including e.g. soybeans (Glycine max.), peanuts (Arachis hypogaea) and pulse crops such as peas including Pisum sativum, pigeon pea and cowpea, beans including broad beans (Vicia faba), Vigna spp., and Phaseolus spp. and lentils (Lens culinaris var.);
brassicaceae, including e.g. canola (Brassica napus), oilseed rape (OSR, Brassica napus), cabbage (B. oleracea var.), mustard such as B. juncea, B. campestris, B. narinosa, B. nigra and B. tourneforti\dot{r}, and turnip (Brassica rapa var.);
other broadleaf crops including e.g. sunflower, cotton, flax, linseed, sugarbeet, potato and tomato;
TNV-crops (TNV: trees, nuts and vine) including e.g. grapes, citrus, pomefruit, e.g. apple and pear, coffee, pistachio and oilpalm, stonefruit, e.g. peach, almond, walnut, olive, cherry, plum and apricot;
turf, pasture and rangeland;
onion and garlic;
bulb ornamentals such as tulips and narcissus;
conifers and deciduous trees such as pinus, fir, oak, maple, dogwood, hawthorne, crabapple, and rhamnus (buckthorn); and
garden ornamentals such as roses, petunia, marigold and snapdragon.

The method or use of the present invention is in particular suitable for burndown of undesired vegetation in fields of the following crop plants: small grain crops such as wheat, barley, rye, triticale and durum, rice, maize (corn), sugarcane, sorghum, soybean, pulse crops such as pea, bean and lentils, peanut, sunflower, sugarbeet, potato, cotton, Brassica crops, such as oilseed rape, canola, mustard, cabbage and turnip, turf, pasture, rangeland, grapes, pomefruit, such as apple and pear, stonefruit, such as peach, almond, walnut, pecans, olive, cherry, plum and apricot, citrus, coffee, pistachio, garden ornamentals, such as roses, petunia, marigold, snap dragon, bulb ornamentals such as tulips and narcissus, conifers and deciduous trees such as pinus, fir, oak, maple, dogwood, hawthorne, crabapple and rhamnus.

The method or use of the present invention is especially suitable for burndown of undesired vegetation in fields of the following crop plants: small grain crops such as wheat, barley, rye, triticale and durum, rice, maize, sugarcane, soybean, pulse crops such as pea, bean and lentils, peanut, sunflower, cotton, Brassica crops, such as oilseed rape, canola, turf, pasture, rangeland, grapes, stonefruit, such as peach, almond, walnut, pecans, olive, cherry, plum and apricot, citrus and pistachio.

In a particular embodiment of the method or the use of the present invention, the binary herbicide combination is used for controlling D. insularis plants in cultures of crop plants which are tolerant to herbicides, in particular in crop plants that are resistant or tolerant to glyphosate and/or salts of glyphosate and which are stacked with further resistance or tolerance against at least one further herbicide, in particular at least one of the following herbicides: auxins such as dicamba, 4-hydroxyphenylpyruvate dioxygenase (HPPD) inhibitors, cellulose synthesis inhibitors, ALS inhibitors, in particular imidazolinones or protoporphyrinogen Oxidase (PPO) inhibitors.

The term “glyphosate-tolerant” means resistance or tolerance to glyphosate and/or salts of glyphosate.

In these herbicide-resistant or -tolerant crops, said combination can be used both for burndown and for control of D. insularis plants after emergence of the crops. Therefore, a particular embodiment of the invention relates to a method for controlling undesirable vegetation in herbicide-resistant or -tolerant crops, in particular in crop plants which are resistant or tolerant to glyphosate and/or salts of glyphosate and which are optionally stacked with further resistance or tolerance against at least one further herbicide, in particular at least one of the following herbicides: auxins such as dicamba, HPPD inhibitors, cellulose synthesis inhibitors, ALS inhibitors, in particular imidazolinones, PPO inhibitors. In this particular embodiment, the method or use according to the invention can be used not only for burndown but also for the control of undesirable vegetation after the crop plants.

Crops which are tolerant to glyphosate and which are optionally stacked with further resistance or tolerance against at least one further herbicide include, but are not limited to soybean and the following crops:
Grain crops, including e.g.
   cereals (small grain crops) such as wheat (Triticum aestivum) and wheat like crops such as durum (T. durum), einkorn (T. monococcum), emmer (T. dicoccon) and spelt (T. spelta), rye (Secale cereale), triticale (Tritiosecale), barley (Hordeum vulgare);
   maize (corn; Zea mays);
   sorghum (e.g. Sorghum bicolour);
   rice (Oryza spp. such as Oryza sativa and Oryza glaberrima); and
   sugar cane;
Legumes (Fabaceae), including e.g. soybeans (Glycine max.), peanuts (Arachis hypogaea and pulse crops such as peas including Pisum sativum, pigeon pea and cowpea, beans including broad beans (Vicia faba), Vigna spp., and Phaseolus spp. and lentils (Lens culinaris var.);
brassicaceae, including e.g. canola (Brassica napus), oilseed rape (OSR, Brassica napus), cabbage (B. oleracea var.), mustard such as B. juncea, B. campestris, B. narinosa, B. nigra and B. tourneforti\dot{r}, and turnip (Brassica rapa var.);
other broadleaf crops including e.g. sunflower, cotton, flax, linseed, sugarbeet, potato and tomato.

In a more preferred embodiment of the method or the use of the present invention, the combination of the herbicide A and the herbicide B are applied to cultures of soybean plants that are glyphosate-tolerant.

In this particular method of the invention, the combination can be applied at least once prior to planting or emergence of the herbicide resistant or tolerant crop plant to achieve effective burndown of D. insularis plants and the combination can also be applied after emergence of the herbicide resistant or tolerant crop plants.

If the combination is used in crop plants, i.e. if it is applied in fields of the crop plants after emergence of the crops, application methods and application rates as described for burndown can be applied. If the active ingredients, i.e. the herbicide A and B are less well tolerated by certain crop plants, application techniques may be used in which the herbicidal combination is sprayed, with the aid of the spray apparatus, in such a way that it comes into as little contact, if any, with the leaves of the sensitive crop plants while reaching the leaves of undesirable plants which grow underneath, or the bare soil (post-directed, lay-by). However such methods are generally not necessary and the combination can be simply applied over the top (OTT).

For example, a combination comprising the herbicide A and B is particularly useful for burndown in fields where a glyphosate tolerant crop having imidazolinone tolerance shall be planted such as maize, canola, wheat, soybeans or sunflower, all of which having glyphosate tolerance and imidazolinone tolerance. Such combination is also useful for burndown in fields where sugarcane shall be planted, the sugarcane being conventional sugarcane or sugarcane being tolerant to glyphosate optionally stacked with tolerance against imidazolinones. The combination can also be used for controlling D. insularis plants in crops having glyphosate resistance stacked with imidazolinone resistance after emergence of the crop.

The active ingredients used in said binary herbicide combination are usually available as pure substances and as formulations. As used herein, the term “active ingredient” refers to the herbicide A and B, i.e. glyphosate, imazamox and their salts. For example, commercial formulations of the herbicide A include Roundup® original, Roundup Transorb® R, Roundup WG®, Crucial®, Zapp QI® 620, Roundup Original® DI, Glyphotal TR, Glizmaz and Xeque Mate, while commercial formulations of imazamox include Raptor® 70 DG. Co-formulation of herbicide A and herbicide B have been described e.g. in U.S. Pat. No. 6,127,317 and can be modified to the requirements of the invention by analogy.

The formulations contain, besides the active ingredient or the composition, at least one organic or inorganic carrier material. The formulations may also contain, if desired, one or more surfactants and, if desired, one or more further auxiliaries customary for crop protection compositions.

The herbicides A and B may be applied together with an adjuvant as action improver. A particular preferred adjuvant is described in WO 00/53014 and in WO2010/037734. Said adjuvant is a combination of a C₁-C₅-alkyl C₅-C₂₂-alkanoate, a C₁₀-C₂₀-carboxylic acid, a partial phosphoric or sulfuric acid ester of a monohydroxy-functional polyalkyl ether and an alkyl polyoxyalkylene polyether. Preferred C₁-C₅-alkyl C₅-C₂₂-alkanoates are methyl oleate, methyl palmitate and ethyl oleate and mixtures thereof. Specifically, the C₁-C₅-alkyl C₅-C₂₂-alkanoate comprises at least 70% by weight of methyl oleate or of a mixture of methyl oleate and methyl palmitate. Such action improver systems are commercially available under the name DASH®, e.g. DASH® HC, from BASF Corporation, USA.

Further action improvers include but are not limited to those adjuvants conventionally used in combination with glyphosate, such as non-ionic surfactants (NIS), ammonium sulfate, alkyl sulfates of C₆₋₁₈ alkanols such as sodium dodecyl sulfate, alkyl ether sulfates of C₆₋₁₈ alkanols, methylated soybean oil (MSO) and crop oil concentrate (COC).

The formulation may be in the form of a single package formulation containing both the at least one herbicide A and the herbicide B together with liquid and/or solid carrier materials, and, if desired, one or more surfactants and, if desired, one or more further auxiliaries customary for crop protection compositions. The formulation may be in the form of a two or multi (e.g. three, four or five) package formulation, wherein one package contains a formulation of the at least one herbicide A while the other package contains a formulation of the at least one herbicide B, wherein all formulations contain at least one carrier material, if desired, one or more surfactants and, if desired, one or more further auxiliaries customary for crop protection compositions. In the case of two or multi package formulations, the formulation containing the herbicide A and the formulation containing the herbicide B are mixed prior to application. Preferably, the mixing is performed as a tank mix, i.e. the formulations are mixed immediately prior or upon dilution with water.

In the formulations the active ingredients and optional further actives are present in suspended, emulsified or dissolved form. The formulation can be in the form of aqueous solutions, powders, suspensions, also highly-concentrated aqueous, oily or other suspensions or dispersions, aqueous emulsions, aqueous microemulsions, aqueous suspo-emulsions, oil dispersions, pastes, dusts, materials for spreading or granules.

Depending on the formulation type, they comprise one or more liquid or solid carriers, if appropriate surfactants (such as dispersants, protective colloids, emulsifiers, wetting agents and tackifiers), and if appropriate further auxiliaries which are customary for formulating crop protection products. The person skilled in the art is sufficiently familiar with the recipes for such formulations. Further auxiliaries include e.g. organic and inorganic thickeners, bactericides, antifreeze agents, antifoams, colorants and, for seed formulations, adhesives.

Suitable carriers include liquid and solid carriers. Liquid carriers include e.g. non-aqueous solvents such as cyclic and aromatic hydrocarbons, e.g. paraffins, tetrahydronaphthalene, alkylated naphthalenes and their derivatives, alkylated benzenes and their derivatives, alcohols such as methanol, ethanol, propanol, butanol and cyclohexanol, ketones such as cyclohexanone, strongly polar solvents, e.g. amines such as N-methylpyrrolidone, and water as well as mixtures thereof. Solid carriers include e.g. mineral earths such as silicas, silica gels, silicates, talc, kaolin, limestone, lime, chalk, bole, loess, clay, dolomite, diatomaceous earth, calcium sulfate, magnesium sulfate, magnesium oxide, ground synthetic materials, fertilizers such as ammonium sulfate, ammonium phosphate, ammonium nitrate, ureas, and products of vegetable origin such as cereal meal, tree bark meal, wood meal and nutshell meal, cellulose powders, or other solid carriers.

Suitable surfactants (adjuvants, wetting agents, tackifiers, dispersants and also emulsifiers) are the alkali metal salts, alkaline earth metal salts and ammonium salts of aromatic sulfonic acids, for example lignosulfonic acids (e.g. Borrespers-types, Borregaard), phenolsulfonic acids, naphthalenesulfonic acids (Morwet types, Akzo Nobel) and dibutylnaphthalenesulfonic acid (Nekal types, BASF AG), and of fatty acids, alkyl-and alkylarylsulfonates, alkyl sulfates, lauryl ether sulfates and fatty alcohol sulfates, and salts of sulfated hexa-, hepta- and octadecanols, and also of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ether, ethoxylated isooctyl-, octyl- or nonylphenol, alkylphenyl or tributylphenyl polyglycol ether, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignosulfite waste liquors and proteins, denaturated proteins, polysaccharides (e.g. methylcellulose), hydrophobically modified starches, polyvinyl alcohol (Mowiol types Clariant), polycarboxylates (BASF AG, Sokalan types), polyalkoxylates, polyvinylamine (BASF AG, Lupamine types), polyethyleneimine (BASF AG, Lupasol types), polyvinylpyrrolidone and copolymers thereof.

Examples of thickeners (i.e. compounds which impart to the formulation modified flow properties, i.e. high viscosity in the state of rest and low viscosity in motion) are polysaccharides, such as xanthan gum (Kelzan® from Kelco), Rhodopol® 23 (Rhone Poulenc) or Veegum® (from R.T. Vanderbilt), and also organic and inorganic sheet minerals, such as Attaclay® (from Engelhardt).

Examples of antifoams are silicone emulsions (such as, for example, Silikon® SRE, Wacker or Rhodorsil® from Rhodia), long-chain alcohols, fatty acids, salts of fatty acids, organofluorine compounds and mixtures thereof.

Bactericides can be added for stabilizing the aqueous herbicidal formulations. Examples of bactericides are bactericides based on diclorophen and benzyl alcohol hemiformal (Proxel® from ICI or Acticide® RS from Thor Chemie and Kathon® MK from Rohm & Haas), and also isothiazolinone derivates, such as alkylisothiazolinones and benzisothiazolinones (Acticide MBS from Thor Chemie).

Examples of antifreeze agents are ethylene glycol, propylene glycol, urea or glycerol.

Examples of colorants are both sparingly water-soluble pigments and water-soluble dyes. Examples which may be mentioned are the dyes known under the names Rhodamin B, C.I. Pigment Red 112 and C.I. Solvent Red 1, and also pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

Examples of adhesives are polyvinylpyrrolidone, polyvinyl acetate, polyvinyl alcohol and tylose.

To prepare emulsions, pastes or oil dispersions, the active components, as such or dissolved in an oil or solvent, can be homogenized in water by means of wetting agent, tackifier, dispersant or emulsifier. Alternatively, it is possible to prepare concentrates consisting of active substance, wetting agent, tackifier, dispersant or emulsifier and, if desired, solvent or oil, and these concentrates are suitable for dilution with water.

Powders, materials for spreading and dusts can be prepared by mixing or concomitant grinding of the active the herbicides A and B with a solid carrier.

Granules, e.g. coated granules, impregnated granules and homogeneous granules, can be prepared by binding the active ingredients to solid carriers.

The formulations comprise a herbicidally effective amount of the binary herbicide combination of the herbicide A and B. The concentrations of the active ingredients in the formulations can be varied within wide ranges. In general, the formulations comprise from 1 to 98% by weight, preferably 10 to 60% by weight, of active ingredients (sum of the herbicide A and B, and optionally further actives). The active ingredients are employed in a purity of from 90% to 100%, preferably 95% to 100% (according to NMR spectrum).

The herbicide A and B, i.e. active compound or composition, can, for example, be formulated as follows:

### Products for Dilution With Water

### A Water-Soluble Concentrates

10 parts by weight of active compound (or composition) are dissolved in 90 parts by weight of water or a water-soluble solvent. As an alternative, wetters or other adjuvants are added. The active compound dissolves upon dilution with water. This gives a formulation with an active compound content of 10% by weight.

### B Dispersible Concentrates

20 parts by weight of active compound (or composition) are dissolved in 70 parts by weight of cyclohexanone with addition of 10 parts by weight of a dispersant, for example polyvinylpyrrolidone. Dilution with water gives a dispersion. The active compound content is 20% by weight.

### C Emulsifiable Concentrates

15 parts by weight of active compound (or composition) are dissolved in 75 parts by weight of an organic solvent (e.g. alkylaromatics) with addition of calcium dodecylbenzenesulfonate and castor oil ethoxylate (in each case 5 parts by weight). Dilution with water gives an emulsion. The formulation has an active compound content of 15% by weight.

### D Emulsions

25 parts by weight of active compound (or composition) are dissolved in 35 parts by weight of an organic solvent (e.g. alkylaromatics) with addition of calcium dodecylbenzenesulfonate and castor oil ethoxylate (in each case 5 parts by weight). This mixture is introduced into 30 parts by weight of water by means of an emulsifier (Ultraturrax) and made into a homogeneous emulsion. Dilution with water gives an emulsion. The formulation has an active compound content of 25% by weight.

### E Suspensions

In an agitated ball mill, 20 parts by weight of active compound (or composition) are comminuted with addition of 10 parts by weight of dispersants and wetters and 70 parts by weight of water or an organic solvent to give a fine active compound suspension. Dilution with water gives a stable suspension of the active compound. The active compound content in the formulation is 20% by weight.

### F Water-Dispersible Granules and Water-Soluble Granules

50 parts by weight of active compound (or composition) are ground finely with addition of 50 parts by weight of dispersants and wetters and made into water-dispersible or water-soluble granules by means of technical appliances (for example extrusion, spray tower, fluidized bed). Dilution with water gives a stable dispersion or solution of the active compound. The formulation has an active compound content of 50% by weight.

### G Water-Dispersible Powders and Water-Soluble Powders

75 parts by weight of active compound (or composition) are ground in a rotor-stator mill with addition of 25 parts by weight of dispersants, wetters and silica gel. Dilution with water gives a stable dispersion or solution of the active compound. The active compound content of the formulation is 75% by weight.

### H Gel Formulations

In a ball mill, 20 parts by weight of active compound (or composition), 10 parts by weight of dispersant, 1 part by weight of gelling agent and 70 parts by weight of water or of an organic solvent are mixed to give a fine suspension. Dilution with water gives a stable suspension with active compound content of 20% by weight.

Aqueous use forms can be prepared from emulsion concentrates, suspensions, pastes, wettable powders or water-dispersible granules by adding water.

It may furthermore be beneficial to apply the combination alone or in combination with other herbicides, or else in the form of a mixture with other crop protection agents, for example together with agents for controlling pests or phytopathogenic fungi or bacteria. Also of interest is the miscibility with mineral salt solutions, which are employed for treating nutritional and trace element deficiencies. Other additives such as non-phytotoxic oils and oil concentrates may also be added.

### Use Examples

The invention is elucidated in more detail by the examples hereinafter.

The experiment was carried out in Brazil, Londrina/PR, at altitude of 450 meters, in season 2018/2019, 2019/2020 and 2021/2022.

A soil sample from the experimental site was analyzed and provided pH H₂O 5.3; 0 cmol_{c} H+Al⁺³/dm³; 4.2 cmol_{c}/dm³ Ca⁺²; 1.6 cmol_{c}/dm³ Mg⁺²; 242 mg/dm³ K⁺; 42.3 mg/dm³ P; 18% sand; 15% silt and 67% clay.

For all herbicide applications, the applications were made using a backpack sprayer that was pressurized by CO₂ with six flat fan nozzles XR110.015 at 3 bar, which caused the application volume to reach 150 L ha⁻¹.

Glyphosate was used as a commercially available soluble concentrate (SL)-formulation containing glyphosate as its potassium salt (480 g/l of glyphosate in its acid form), which is commercially available under the trade name Roundup Transorb R.

Imazamox was used as a commercially available water dispersible granule (WG)-formulation containing 700 g/Kg of imazamox, which is commercially available under the trade name Raptor® 70 DG.

In table 1, all details related to mode of application of herbicides, and climatic conditions during herbicide application are listed.

TABLE 1
Descriptive details concerned to herbicide applications
performed during this experiment.

| | A | B | A* |
|---|---|---|---|
| Modality | Post-emergence | Post-emergence | Post-emergence |
| | of weeds - | of weeds - | of weeds; no |
| | desiccation 30 | desiccation 0 | soybean |
| | days before | days before | sowing |
| | soybean | soybean | |
| | sowing | sowing | |
| Date | 27 Sep. 2019 | 24 Nov. 2020 | 16 Nov. 2021 |
| Period of the day | 9:00 AM | 17:50 PM | 8:00 AM |
| Air temp. [° C.] | 31 | 28 | 29 |
| Air moisture [%] | 48 | 53 | 51 |
| Wind speed | 1.3 | 2.4 | 1.4 |
| [km/h] | | | |
| Soil cover | 70 | 80 | — |
| Light (cloud | 90% | 83% | clear |
| cover) | | | |
| Weed infestation | D. insularis | D. insularis | D. insularis |
| and stage | (perennial) | (flowering stage) | (early stage - 2 to |
| | (20 plants m⁻²) | (55 plants m⁻²) | 6 leaves) |
| | | | (5 plants m⁻²) |

Crop sowing (in case of A and B; in case of A*, no crops were sown) was carried out under a no-tillage system, by distributing 16 seeds per meter of a M6410® soybean variety in all treatments with Raptor® 70 DG and also 16 seeds m⁻¹ of a second soybean cultivar (BMX Potência RR) in the remaining treatments. Immediately before sowing, the seeds of both cultivars were treated with a formulation of fipronil, pyraclostrobin and thiophanate methyl (Standak® Top; 200 mL per ha). Crop fertilization was performed with 300 kg ha⁻¹ of a commercial N-P-K formulation (02-20-18).

For the post-emergence treatment, the test plants were first grown to a height of 3 to 20 cm, depending on the plant habit, and only then treated. Here, the herbicidal compositions were suspended or emulsified in water as distribution medium and sprayed using finely distributing nozzles.

Herbicide B was formulated as 10% by weight strength suspension concentrate and introduced to the spray liquor with the amount of solvent system used for applying the active compound. Herbicide A was used as commercially available formulations and introduced to the spray liquor with the amount of solvent system used for applying the active compound. In the examples, the solvent used was water.

After the first application (application “A” and “A*”), two evaluations were performed on the effect of treatments on the weeds emerged at that application. For those evaluations, the infestation of the untreated control is used as reference. These assessments for the damage caused by the herbicides A and B, and the binary herbicide combination thereof were carried out at 14 days after application “A” (14 DAA-A) or 35 days after application “A*” (35-DAA-A*) using a scale from 0 to 100%, compared to the untreated control plants. Here, 0 means no damage and 100 means complete destruction of the plants.

Another evaluation was performed after the second applications (application “B”) to analyse the effect of treatments on the control of remaining emerged flora (D. insularis) at the time of application. Likewise, for these evaluations, the same visual scale 0-100% was used and weed control efficiency was rated at 28 days after application “B” (28 DAA-B).

Colby's formula was applied to determine whether the composition showed synergistic action. The value E, which is to be expected if the activity of the individual compounds is just additive, was calculated using the method of S. R. Colby (1967) “Calculating synergistic and antagonistic responses of herbicide combinations”, Weeds 15, p. 22 ff. For two component mixtures the value E was calculated by the following formula

$$E = X + Y - ( X \cdot Y / 100 )$$

where X=effect in percent using herbicide A at an application rate a;
Y=effect in percent using herbicide B at an application rate b;
E=expected effect (in %) of A+B at application rates a+b.

If the value observed in this manner is higher than the value E calculated according to Colby, a synergistic effect is present.

Synergism is the ratio observed effect to the expected effect E in %.

The results are summarized in the following tables 2, 3 and 4 that show the herbicidal activity of the individual actives and of their combinations in post-emergence application assessed 14, 28 and 35 day after treatment (DAT), respectively.

TABLE 2
Application in post-emergence of the herbicide
A and B (application A), 14 DAA-A

| | | | Control | |
|---|---|---|---|---|
| | | | (%) of | |
| | | Dose | D. insularis | Synergistic |
| Treatment | | [g ai/ha]^{a} | (perennial) | effect [%] |
| No treatment | | 0 | 0 | — |
| Solo | Herbicide A | 1080 | 5 | — |
| application | (glyphosate) | | | |
| | Herbicide B | 49 | 13 | — |
| | (Imazamox) | | | |
| | Herbicide B | 70 | 20 | — |
| | (Imazamox) | | | |
| | Herbicide B | 91 | 20 | — |
| | (Imazamox) | | | |
| Binary | Herbicide A + B | 1080 + 49 | 70 | 403.5 |
| combination | (glyphosate + | | | |
| | Imazamox) | | | |
| | Herbicide A + B | 1080 + 70 | 75 | 312.5 |
| | (glyphosate + | | | |
| | Imazamox) | | | |
| | Herbicide A + B | 1080 + 91 | 78 | 325 |
| | (glyphosate + | | | |
| | Imazamox) | | | |

All treatments were sprayed with DASH ® 0.5% v/v
^{a}grams of active ingredient (calculated as the acid form) per hectare

TABLE 3
Application in post-emergence of the herbicide
A and B (application B), 28 DAA-B

| | | | Control | |
|---|---|---|---|---|
| | | | (%) of | |
| | | Dose | D. insularis | Synergistic |
| Treatment | | [g ai/ha]^{a} | (flowering) | effect [%] |
| No treatment | | 0 | 0 | — |
| Solo | Herbicide A | 1440 | 45 | — |
| application | (glyphosate) | | | |
| | Herbicide B | 70 | 40 | — |
| | (Imazamox) | | | |
| | Herbicide B | 105 | 40 | — |
| | (Imazamox) | | | |
| | Herbicide B | 140 | 50 | — |
| | (Imazamox) | | | |
| Binary | Herbicide | 1440 + 70 | 70 | 104.5 |
| combination | A + B | | | |
| | (glyphosate + | | | |
| | Imazamox) | | | |
| | Herbicide | 1440 + 105 | 70 | |
| | A + B | | | |
| | (glyphosate + | | | |
| | Imazamox) | | | |
| | Herbicide | 1440 + 140 | 70 | |
| | A + B | | | |
| | (glyphosate + | | | |
| | Imazamox) | | | |

All treatments were sprayed with DASH ® 0.5% v/v
^{a}grams of active ingredient (calculated as the acid form) per hectare

TABLE 4
Application in post-emergence of the herbicide
A and B (application A*), 35 DAA-A*

| | | | Control | |
|---|---|---|---|---|
| | | | (%) of | |
| | | | D. insularis | |
| | | | (early stage - | |
| | | Dose | 2 to 6 | Synergistic |
| Treatment | | [g ai/ha]^{a} | leaves) | effect [%] |
| No treatment | | 0 | 0 | — |
| Solo | Herbicide A | 1080 | 5 | — |
| application | (glyphosate) | | | |
| | Herbicide B | 105 | 13 | — |
| | (Imazamox) | | | |
| Binary | Herbicide | 1080 + 105 | 75 | 432.3 |
| combination | A + B | | | |
| | (glyphosate + | | | |
| | Imazamox) | | | |

All treatments were sprayed with DASH ® 0.5% v/v
^{a}grams of active ingredient (calculated as the acid form) per hectare

1. A method for controlling Digitaria insularis plants, comprising applying a binary herbicide combination of
i. an herbicide A selected from glyphosate and a salt of glyphosate, and
ii. an herbicide B selected from imazamox, a salt of imazamox and an ester of imazamox,
to an area where the Digitaria insularis plants grow or may grow,
wherein a weight ratio of the herbicide A to the herbicide B in the binary herbicide combination is in a range of 1:2 to 120:1.

2. A binary herbicide combination of
i. an herbicide A selected from glyphosate and a salt of glyphosate, and
ii. an herbicide B selected from imazamox, a salt of imazamox and an ester of imazamox,
for controlling Digitaria insularis plants,
wherein a weight ratio of the herbicide A to the herbicide B in the binary herbicide combination is in a range of 1:2 to 120:1.

3. The method according to claim 1, wherein the Digitaria insularis plants are glyphosate-tolerant.

4. The method according to claim 1, wherein the binary herbicide combination is applied to a culture of soybean where the Digitaria insularis plants grow or may grow.

5. The method according to claim 1, wherein the binary herbicide combination is applied to an area where it is intended to plant soybean.

6. The method according to claim 4, wherein the soybean plants are glyphosate-tolerant.

7. The method according to claim 1, comprising:
i. applying the herbicide A to an area where Digitaria insularis plants grow or may grow; and
ii. applying the herbicide B to said area,
wherein the application steps i) and ii) are performed either successively or simultaneously, such that both the herbicide A and the herbicide B are present on said area in the weight ratio of A to B in the range of 1:2 to 120:1.

8. The method according to claim 1, wherein the weight ratio of the herbicide A to the herbicide B is in the range of 1:1 to 50:1.

9. The method according to claim 8, wherein the weight ratio of the herbicide A to the herbicide B is in the range of 8:1 to 22:1, wherein a weight ratio of glyphosate to imazamox refers to a weight of the acid form of glyphosate and imazamox, respectively.

10. The method according to claim 1, wherein the herbicide A is applied with an application rate in a range of from 0.24 to 2.4 kg/ha, calculated as glyphosate in its acid form.

11. The method according to claim 1, wherein the herbicide B is applied with an application rate in a range of from 0.02 to 0.56 kg/ha, calculated as imazamox in its acid form.

12. The method according to claim 1, which further comprises preparing a mixture of the herbicide A and the herbicide B prior to application.

13. The method according to claim 12, wherein the herbicide A and the herbicide B are tank-mixed.

14. The method according to claim 1, wherein the binary herbicide combination is applied to growing Digitaria insularis plants.

15. The method according to claim 14, wherein the binary herbicide combination is applied to the Digitaria insularis plants that form at least above-ground basal branches.

16. The method according to claim 1, wherein the herbicide A is a glyphosate salt selected from the group consisting of glyphosate-monoammonium, glyphosate-diammonium, glyphosate-isopropylammonium, glyphosate-potassium, glyphosate-sesquisodium, and glyphosate-trimesium.

17. The method according to claim 1, wherein the herbicide B is a R-enantiomer of imazamox.

18. The method according to claim 1, wherein the herbicide B is selected from imazamox and a salt of imazamox.

19. The method according to claim 1, wherein the herbicide B is imazamox in its free acid form.

20. The method according to claim 1, wherein the herbicide B is an imazamox salt selected from the group consisting of imazamox-monoammonium, imazamox-isopropylammonium, imazamox-C₁-C₄-alkylammonium, such as imazamox-isopropylammonium; imazamox-di-(C₁-C₄-alkyl)ammonium, imazamox-potassium, and imazamox-tri-(C₁-C₄-alkyl)sulfonium.
